(19) United States
(12) Patent Application Publication
(10) Pub. No.: US 2025/0367981 A1
(43) Pub. Date: Dec. 4, 2025

(54) TIRE WITH SIMPLIFIED CARCASS REINFORCEMENT

(71) Applicant: COMPAGNIE GENERALE DES ETABLISSEMENTS MICHELIN, Clermont-Ferrand (FR)

(72) Inventors: SYLVERE MAILLARD, Clermont-Ferrand (FR); VALERIE-ANICIA BOIX, Clermont-Ferrand (FR); VIVIANE BOMBLAIN, Clermont-Ferrand (FR); JOSE MERINO LOPEZ, Clermont-Ferrand (FR); MATHIEU VANDAELE, Clermont-Ferrand (FR)

(21) Appl. No.: 19/107,308

(22) PCT Filed: Aug. 4, 2023
(86) PCT No.: PCT/EP2023/071668

§ 371 Date: Feb. 27, 2025

(30) Foreign Application Priority Data
Aug. 31, 2022 (FR) FR2208716

(51) Int. Cl. B60C 15/00; B60C 9/00; B60C 9/02

(52) U.S. Cl. CPC B60C 15/0018; B60C 9/0042; B60C 9/0207; B60C 2009/0092; B60C 2009/0276

(57) ABSTRACT

A motor vehicle tire is designed for standardized manufacture of its carcass reinforcement comprising two layers. A first layer (41) is anchored in the two beads (50) by a turn-up (53) around a bead wire (51), so as to form, in each bead, a main part (52) and a turn-up (53). A second layer (42) is laid axially and radially on the outside of the first carcass layer, and positioned in the bead axially on the inside of the turn-up of the first carcass layer. The first carcass layer (41) has a turn-up (53) of length HNC1 ranging between 10% and 30% of the height of one of the sidewalls (30); the length LREC is comprised in the range [0.6*HNC1; 0.9*HNC1], and the maximum value of the distances (LNDEG, LNDED) is comprised in the range [2; 18] mm.

### FIELD OF THE INVENTION

The present invention relates to a motor vehicle tyre designed for standardized manufacture of its carcass reinforcement comprising two carcass layers.

### DEFINITIONS

By convention, consideration is given to a frame of reference (O, OX, OY, OZ), the centre O of which coincides with the centre of the tyre; the circumferential direction OX, axial direction OY and radial direction OZ refer to a direction tangential to the tread surface of the tyre in the direction of rotation, to a direction parallel to the axis of rotation of the tyre, and to a direction orthogonal to the axis of rotation of the tyre, respectively.

Radially inner and radially outer mean closer to and further away from the axis of rotation of the tyre, respectively.

Axially inner and axially outer mean closer to and further away from the equatorial plane of the tyre, respectively, the equatorial plane of the tyre being the plane that passes through the middle of the tread of the tyre and is perpendicular to the axis of rotation of the tyre.

The make-up of the radial tyre is usually described by a representation of its constituent components in a meridian plane, which is to say a plane containing the axis of rotation of the tyre. Such a choice is motivated by the axisymmetry of the geometry of the tyre about its axis of rotation. The tyre also comprises a plane of symmetry which is orthogonal to the axis of rotation and passes through the centre of the tread: this is the equatorial plane.

A radial tyre is intended to come into contact with the ground via a tread, the two axial ends of which are connected via two sidewalls to two beads that provide the mechanical connection between the tyre and the rim on which it is intended to be mounted.

A radial tyre also comprises a reinforcement made up of a crown reinforcement radially on the inside of the tread and of a carcass reinforcement radially on the inside of the crown reinforcement.

The crown reinforcement of a radial tyre comprises a superposition of crown layers extending circumferentially, radially on the outside of the carcass reinforcement. Each crown layer is made up of reinforcers that are parallel to one another and coated in a polymer material of the elastomer or elastomer compound type. The assembly consisting of the crown reinforcement and the tread is called the crown.

The carcass reinforcement of a radial tyre usually comprises at least one carcass layer made up of metal or textile reinforcing elements coated in an elastomer coating compound. The reinforcing elements are substantially parallel to one another and form an angle of between 85° and 95° with the circumferential direction. The carcass layer comprises a main part which joins the two beads together and is wrapped, in each bead, around an annular reinforcing structure, which is most often a bead wire for forming a turn-up loop.

Each bead is thus situated radially furthest on the inside so as to be in contact with a rim and comprises, at least partially, the following components:
1. At least in part, an airtight layer which lines the inner cavity of the tyre;
2. A carcass reinforcement comprising at least a first carcass layer positioned axially and radially on the outside of the first airtight layer;
3. A bead filler layer which fills the volume defined by the turn-up loop of the first carcass layer of the carcass reinforcement about the bead wire;
4. A bead wire formed by an assembly of cords;
5. A reinforcing filler layer of the bead axially on the outside of the turn-up of the first carcass layer;
6. An axially innermost protective layer in part making up the outer periphery of the tyre and intended to be in contact with the rim;
7. A connecting layer between the carcass reinforcement and the crown of the tyre;
8. An axially outermost sidewall layer making up the outer wall of the tyre that is in contact with the surrounding environment.

For large sizes with rim diameters of more than 16 inches, most often the carcass reinforcement comprises a second carcass layer, in addition to a first carcass layer turned up around the bead wire. Depending on the positioning of this second carcass layer, a distinction is made between type A beads and type B beads.

For the type A beads, the second carcass layer is laid axially and radially on the outside of the first carcass layer. In this bead, the second carcass layer is axially on the outside of the turn-up of the first carcass layer.

For the type B beads, the second carcass layer is also laid axially and radially on the outside of the first carcass layer, but the second carcass layer is axially on the inside of the turn-up of the first carcass layer, and in contact with the main part of the first carcass layer before its turn-up around the bead wire.

Radial tyres, as presented above, and more specifically non-vulcanized toroidal green tyres therefor, are usually manufactured by a process having two distinct phases. In the first phase, the cylindrical blank of the carcass reinforcement is manufactured on a cylindrical tyre building drum, said blank comprising, among other things, the carcass reinforcement itself, the elastomer compounds and reinforcers inside said reinforcement, and all the elements making up the beads, namely the bead wires, the bead filling layers and profiled elements, and the bead reinforcements.

Then, the parts of the blank situated radially underneath the bead wires are made to radially expand until said parts are locked underneath the bead wires. Then, the part situated between the bead recesses is radially deformed to obtain a toroidal shape, while at the same time moving said recesses axially closer together. The clamping underneath the bead wires should be sufficient to prevent any relative movement with respect to the bead wires during this operation. This operation, during which first of all the beads and then the sidewalls of the tyre are formed, is referred to as “ply turning”.

In a second phase, the cylindrical blank of the carcass reinforcement is shaped, expanded into a toroidal shape on which the elements making up the crown reinforcement, the rubber layers and profiled elements separating said crown reinforcement from the carcass reinforcement, and the tread will then be laid.

The toroidal and non-vulcanized green tyre is then introduced into a vulcanizing mould, said green tyre undergoing a slight additional shaping to afford the final dimensions of the tyre.

Upstream of the first fabrication step is the preparation of the separate parts, which is to say the preparation of the semi-finished products which are profiled elements of elastomer compounds obtained by virtue of extruders provided at the outlet with a suitable tool for producing parts of elastomer compounds that are suitable for the manufacture of each item of the tyre. Still during this preparation phase, the layers of fabrics are cut to the widths derived from the geometry of the tyre on the basis of the design.

With assistance from technical advancements, tyre building machines are increasingly being automated. The steps described above are introduced into an automatic tyre building machine which comprises the shaping drum which is moved in front of the stations for winding the semi-finished products in steps corresponding to the laying of the products 1 to 8 that were described above.

Automatic tyre building machines are configured for type A beads or for type B beads. Nowadays, difficulties are encountered in successively manufacturing a first bead of type A and then a second bead of type B, and vice versa, on these machines without making adaptations which adversely affect the industrial performance.

Such an adaptation consists, for example, in modifying the automatic tyre building machine by adding an additional fabrication station for affording flexibility in order to be able to manufacture the two types of beads.

### PRIOR ART

Document FR2900097A1 contains references to the type A and type B beads, in the context of designing an extended-mobility tyre with self-supporting sidewalls. However, this design requires adaptations from one type to the other during the manufacture.

With regard to document EP0595653A1, presented is a bead which is of type A but has reinforcing layers coated in additional elastomeric compounds in relation to the conventional solutions. This solution has the drawback of increasing the industrial production cost of the tyre.

Documents DE102015207714A1 and WO02/096676A1 disclose tyre architectures involving carcass reinforcements with at least two carcass layers for improving the performance of the tyre. Documents U.S. Pat. No. 6,273,164B1 and US2019/001758A1 deal with tyres for motorcycles which have carcass reinforcements also of two layers.

The inventors have set themselves the objective of designing an architecture of the bead of a tyre which advantageously replaces the type A and B beads, without adversely affecting the technical and industrial performance.

### DISCLOSURE OF THE INVENTION

This aim has been achieved by the design of a passenger vehicle tyre comprising the following in a meridian plane:
two beads intended to be mounted on a rim, two sidewall layers connected to the beads, and a crown having a tread intended to come into contact with the ground, the crown having a first side connected to the radially outer end of one of the two sidewall layers and a second side connected to the radially outer end of the other one of the two sidewall layers;
a carcass reinforcement comprising two carcass layers extending from the two beads through the sidewalls as far as the crown, and each comprising a plurality of carcass reinforcing elements;
the first carcass layer being anchored in the two beads by a turn-up around a reinforcing bead wire, so as to form, in each bead, a main part and a turn-up;
a bead filler layer, of elastomer compound, occupying the volume delimited by said main part, the turn-up, and at least partially the radially outer contour of the bead wire;
the radial distances (LNDEG, LNDED) being defined in a first and in a second bead (50) as being the radially inner distances of a first and of a second end of the second carcass layer (42) from an axial straight line B1 tangential to the bead wire at its radially outermost point;
the second carcass layer being laid axially and radially on the outside of the first carcass layer, and positioned in the bead axially on the inside of the turn-up of the first carcass layer, and axially on the outside of the bead filler layer such that the second carcass layer is in contact with the turn-up of the first carcass layer over a length LREC;
in each bead, the first carcass layer has a turn-up of length HNC1 ranging between 10% and 30% of the height of one of the sidewalls of the tyre, said length HNC1 being measured from a first, radially innermost point of the bead wire to a second point constituting a radially outermost end of the turn-up of the first carcass layer; the length LREC is comprised in the range [0.6*HNC1; 0.9*HNC1], the maximum value of the distances (LNDEG, LNDED) is comprised in the range [2; 18] mm,.

A tyre of the invention differs from the prior art in that the architecture of the bead comprises a second carcass layer which is positioned axially and radially on the outside of the first carcass layer. In the bead, the second carcass layer is positioned axially on the inside of the turn-up of the first carcass layer and axially on the outside of the bead filler layer. The relative positions of the ends of the products in the beads are such that the technical performance of the product is ensured, and the industrial performance is maintained in comparison with the manufacture of conventional solutions. The beads of the invention advantageously replace the type A or B beads without adversely affecting the industrial performance or the technical performance.

A bead of a tyre of the invention comprises a stack of layers of reinforcers coated in elastomer compounds: the main part, the turn-up of the first carcass layer, and a portion of the second carcass layer. The material properties of the elastomer compounds of the bead, the thicknesses and the lengths of overlap of the layers are defined so as to optimize the operation of the bead.

According to the invention, the length of the turn-up of the first carcass layer ranges between 10% and 30% of the height of the sidewall of the tyre. This sidewall height is standardized for each tyre size, and is accessible for example in the Standards Manual of the ETRTO (European Tyre and Rim Technical Organisation). It is also possible to estimate its value from the standardized designation of the tyre. The inventors have set the length of the turn-up HNC1 on the basis of the height of the sidewall so as to generalize the operation of the invention for all passenger vehicle tyre sizes. When HNC1 is equal to approximately 10% of the height of the sidewall, the unwinding of the reinforcer of the first carcass layer underneath the bead wire is avoided. Specifically, if the length of the turn-up is insufficient, which is to say less than 10% of the sidewall height, the tensions in the first carcass layer cause the reinforcers to retract, and the tyre can undergo irreversible damage. According to the inventors, HNC1 should be less than 30% of the sidewall height so as to avoid the zone of maximum bending when the tyre is rotating and compressed by the load that is borne.

Within the context of the invention, a mechanically coupled state in a stack of composite layers of at least two layers each comprising reinforcers coated in an elastomer compound is defined for an inflated tyre mounted on a rim, by being subjected to an inflation pressure of 250 kPa. In these stress conditions, the mechanically coupled state is attained when the shear stresses in the axial and radial directions in the elastomer compound situated between the reinforcers are constant over the entire length of the stack. In these conditions, the tensile stiffness in the reinforcers is at its greatest, and the stack of composite layers contributes to its full potential to the operation of the bead.

A first condition for attaining the mechanical coupling in the stack of composite layers of the bead is for the radial distance between the centres of two adjacent reinforcers of a first and a second layer of the stack to be less than one and a half times the diameter of a reinforcer of said layers. A second condition is to have a sufficient length of overlap between the turn-up of the first carcass layer and a radially inner portion of the second carcass layer. According to the inventors, within the context of passenger vehicle tyres a length LREC of overlap comprised within the range [0.6*HNC1; 0.9*HNC1] is sufficient.

The criterion of mechanical coupling of the layers of a stack is expressed as a function of the diameter of the reinforcers of said layers. To determine the diameter of a textile reinforcer, use is made of an apparatus which, by means of a receiver composed of a collecting optical system, a photodiode and an amplifier, enables the shadow of the reinforcer illuminated by a laser beam of parallel light to be measured with an accuracy of 0.1 micrometre. Such an apparatus is marketed, for example, by Z-Mike, under the reference “1210”. The method consists in fixing a specimen of the reinforcer whose diameter is to be measured to a powered moving table under a standard pre-tension of 0.5 centinewtons per tex (cN/tex), after the reinforcer has undergone preliminary conditioning. When fixed to the moving table, the reinforcer is moved perpendicularly to the drop shadow measurement system at a speed of 25 mm/s, and cuts the laser beam orthogonally. At least 200 drop shadow measurements are made over a length of 420 mm of cord; the mean of these drop shadow measurements represents the diameter of the reinforcer.

To make industrial manufacture easier, the inventors propose that the maximum value of the distances (LNDEG, LNDED), which represents the maximum distance from the radially innermost end of the second carcass layer to the axial straight line B1 tangential to the bead wire at its radially outermost point, is comprised in the range [2; 18] mm.

Still for industrial optimization purposes, advantageously, in each bead the axial thickness, EBT, of the bead filler layer measured from a radially innermost end of the second carcass layer to the main part of the first carcass layer is comprised in the range [EBTmin; EBTmax], where EBTmin is equal to 0.5 times the outside diameter of the bead wire, and EBTmax is equal to 1.2 times the outside diameter of this same bead wire.

The combination of the main features of the invention results in the tyre of the invention, which makes it possible to advantageously replace the type A and/or B beads in manufacture while still ensuring a level of identical performance.

In addition to the main features of the invention, the inventors have identified levers linked to the geometry of the products and their material properties in order to even better optimize the compromise in technical and industrial performance.

The distances (LNDEG, LNDED) are examples of dimensions for the architecture of the tyre that enable adjustments of the lengths of the carcass layers. Advantageously, the distances (LNDEG, LNDED) are identical in each of the two beads.

Having the same distance (LNDEG, LNDED) on either side of the equatorial plane causes the carcass reinforcement to be centred in relation to the axis (OZ), the effect of which is to contribute to improving the uniformity of the tyre, while avoiding imbalances which would be linked to a distribution of the masses and forces which would not conform to the symmetries of the tyre.

According to one embodiment of the invention, the second carcass layer is discontinuous. The second carcass layer can be compressed in a zone situated in the centre of the tread, after the tyre has been inflated and mounted on a rim. According to the inventors, it is possible to eliminate the portion of the second carcass layer that is in this compression zone. In these conditions, the second carcass layer takes the form of two portions positioned on either side of the equatorial plane, and extending from the bead to the shoulder of the tyre.

There are other configurations in which the second carcass layer is discontinuous, when for example it is made up of a succession of portions of carcass layers.

With preference, the distributed breaking tension of each of the carcass layers is greater than or equal to 11 daN/mm, the distributed breaking tension being the product of the breaking force of a reinforcer of a layer times the pitch of the layer.

The distributed tension in a layer is the product of the stress in the direction of the reinforcers times the thickness of said carcass layer. According to the inventors, each carcass layer should be sufficiently sized with a distributed tension value of at least 11 daN/mm. The length of the second carcass layer may be reduced depending on the values assigned to LREC and (LNDEG, LNDED), and HNC1, but the carcass reinforcement as a whole should retain sufficient tensile strength in the direction of the reinforcers.

With preference, the first and second carcass layers are made of the same materials. This embodiment is motivated for reasons of standardization and therefore reduction of material costs, by using the same materials for the two carcass layers. To enhance this standardization, not only are the materials the same but the nature and assembly of the reinforcers, the density of the reinforcers in each layer, and the elastomer compound for coating are identical.

With preference, the reinforcers of the carcass layers are textile cords, each cord being obtained by twisting a twist T2 of N strands of a textile material in a given direction D1 (respectively in the S or Z direction), with N≥1, each strand resulting from overtwisting a twist T1 of a spun yarn of said textile material in an opposite direction D2 (Z or S, respectively).

With preference, the spun yarns are made of a hybrid assembly of filaments of textile materials (such as nylon, PET, aramid).

Advantageously, the number N of strands for the twisting ranges between 2 and 6, and preferentially N=2.

Preferentially the overtwisting twist T1 and the twisting twist T2 are identical, and less than 500 turns per metre, preferentially T1 and T2 are identical and less than 440 turns per metre, and more preferentially still T1 and T2 are identical and less than or equal to 315 turns per metre.

According to another embodiment, in each bead, a lateral reinforcing layer of the bead is positioned axially on the outside of the turn-up of the first carcass layer, and in contact on one side with said turn-up and on the other side at least partially, axially on the outside, with a sidewall layer.

According to this particularly advantageous embodiment, the bead filler layer and the lateral reinforcing layer of the bead are made of the same elastomer compound provided with an elastic shear modulus greater than or equal to 25 MPa, said modulus being measured under alternating strain at a frequency of 10 Hz and at a temperature of 23° C.

### BRIEF DESCRIPTION OF THE DRAWINGS

Further details and advantageous features of the invention will become apparent in the following text from the description of exemplary embodiments of the invention given with reference to the figures, which show meridian views of designs of a tyre according to the embodiments. In order to make them easier to understand, the figures are not shown to scale.

FIG. 1 comprises a view 1-A which shows a cross section through a tyre of the invention in a meridian plane, and a view 1-B which represents an enlarged view of a portion of the meridian view 1-A surrounded by a dashed circle showing a bead of a tyre of the invention.

FIGS. 2-A, 2-B show tyres of the prior art with type A beads (FIG. 2-A) and type B beads (FIG. 2-B).

FIGS. 3-A and 3-B show embodiments in which the first and/or the second carcass layer are discontinuous.

As regards FIG. 4, it shows a bead of a tyre of the invention, with a schematic view of the main dimensions of the invention.

### DETAILED DESCRIPTION OF THE INVENTION

The invention was implemented on a passenger vehicle tyre of size 245/70R16 in accordance with the specifications of the ETRTO (European Tyre and Rim Technical Organisation) standard. Such a tyre, with a load index of 111, can bear a load of 1090 kilos, inflated to a pressure of 290 kPa.

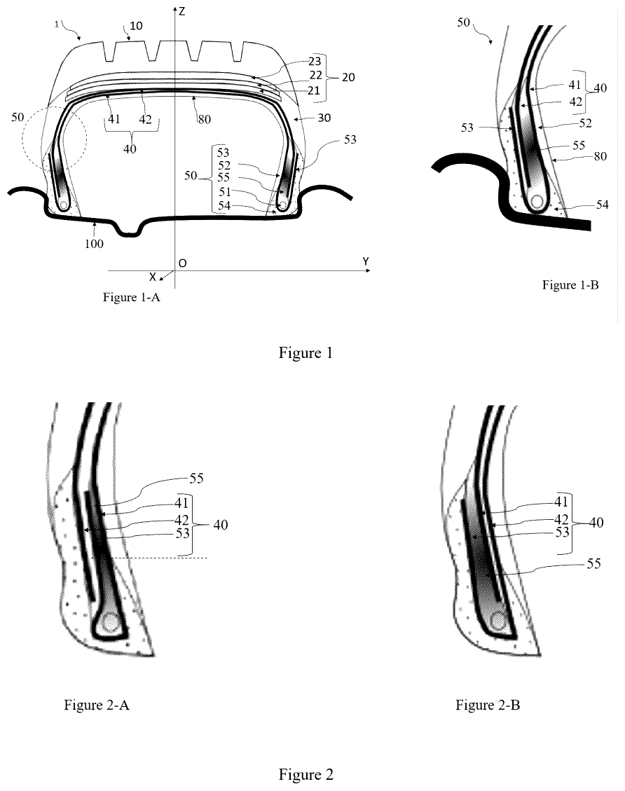

In FIG. 1-A, the tyre of overall reference 1 comprises a carcass reinforcement 40 made up of a first carcass layer 41 which comprises a main part 52 which joins two beads 50 together and is wrapped, in each bead 50, around an annular reinforcing structure. The annular reinforcing structure is a bead wire 51 which comprises a stiff circumferential element, most often metallic, wrapped in at least one, non-limitingly metallic, elastomer or textile, material. The carcass layer 41 is wrapped around the bead wire 51 from the inside towards the outside of the tyre 1 to form a turn-up 53 comprising a radially outer end. The turn-up 53, in each bead 50, allows the carcass layer 41 to be anchored to the bead wire 51 of the bead 50.

The reinforcing elements of each carcass layer (41, 42) are substantially parallel to one another and form an angle of between 85° and 95° with the circumferential direction.

Each bead 50 comprises a bead filler layer 55 which continues the bead wire 51 radially outwards. The bead filler layer 55 consists of at least one elastomer filler compound. The filler layer axially separates the main part 52 and the turn-up 53 of the carcass reinforcement 41.

Each bead 50 also comprises a protective layer 54 which continues the sidewall 30 radially towards the inside and which is axially on the outside of the turn-up 53. The protective layer 54 is also at least partially in contact, via its axially outer face, with a flange of a rim 100. The protective layer 54 consists of at least one protective elastomer compound.

The tyre 1 also has a crown reinforcement 20 comprising two working layers 21, 22 and a hooping layer 23. Each of the working layers 21 and 22 is reinforced by filamentary reinforcing elements which are parallel in each layer and crossed from one layer to the next, making angles of between 10° and 70° with the circumferential direction. The hooping layer 23, positioned radially on the outside of the layers (21, 22), is formed of circumferentially oriented reinforcing elements wrapped in a spiral in the axial width of the crown. A tread 10 is laid radially on the outside of the hooping layer 23; it is this tread 10 which provides the contact between the tyre 1 and the ground. The tyre 1 depicted is a “tubeless” tyre: it comprises an “inner liner” 80 made of a rubber composition impermeable to the inflation gas, covering the inner surface of the tyre.

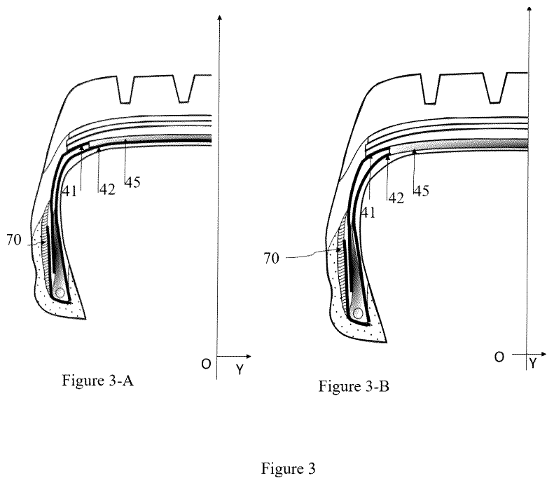

FIGS. 2-A, 2-B show tyres of the prior art with type A beads (FIG. 2-A) and type B beads (FIG. 2-B). These figures contain the carcass reinforcement 40 comprising the carcass layers (41, 42) and the turn-up 53. The bead filler layer 55 is a layer of elastomer compound filling the volume delimited by the main part of the first carcass layer 41 and its turn-up 53.

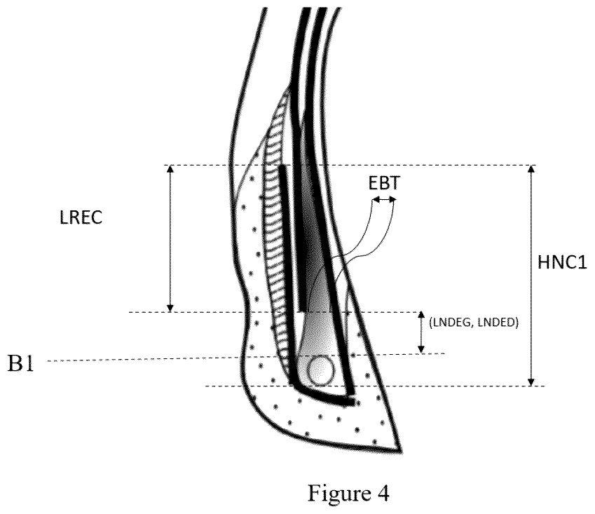

FIGS. 3-A, 3-B show exemplary embodiments of a tyre of the invention with non- continuous layers of the carcass reinforcement. In FIG. 3-A, the second carcass layer is truncated over a zone which extends in the centre of the crown, whereas in FIG. 3-B, both carcass layers are truncated in this same zone. In the two cases in which the carcass layers are discontinuous, a layer 45 of elastomer compound is replaced by the locally absent carcass layers. The addition of a lateral reinforcing layer 70 may prove to be necessary to keep the stiffness of the bead at a sufficient level for the tyre to operate well.

FIG. 4 shows the main dimensions of the architecture of a bead of a tyre of the invention. In a bead, the dimension LREC denotes the length of the contact zone between the turn-up 53 of the first carcass layer 41 and a radially inner part of the second carcass layer 42. The dimension LREC is involved in the mechanical coupling of the stack made up of the main part 52 of the first carcass layer 41, the turn-up 53 and the radially inner part of the second carcass layer 42. When LREC is assigned a sufficient value to establish the mechanical coupling, the stack of composite layers forms a stiff block which gives the bead the maximum level of radial and axial stiffnesses. The thickness of the bead filler layer, EBT, and its elastic shear modulus are other parameters involved in the establishment of the mechanical coupling of the stack. The length HNC1 of the turn-up should be sufficient to avoid the unwinding of the first carcass layer underneath the bead wire, without being located in the compression zone following the compression of the tyre by the load that is borne. The radial lengths LNDEG and LNDED are associated with the development of the deconstruction of the tyre of the invention. The deconstruction of a tyre consists, taking the vulcanized theoretical version designed for example by computer-assisted design as a basis, in going back to the non-vulcanized separate parts, which are then stacked around the tyre building and finishing drums. The radial length LNDED is the symmetrical length of LNDEG with respect to the axis (OZ) in the second bead of the tyre.

Configurations of tyres of the invention were tested in order to clearly highlight the performance afforded by the invention. The results of these tests were compared with those obtained on control tyres.

A first control C1 is a tyre of conventional design which has a type A bead, and a second control tyre C2 has a type B bead. Each of the tyres (C1, C2) comprises two carcass layers (41, 42) made of the same materials: each carcass layer (41, 42) comprises reinforcers made of polyester that are formed of two threads each of which has a count of 140 tex and which are overtwisted and twisted, under a tension of 420 turns per metre, and coated with an elastomer compound. The distributed breaking tension in a carcass layer is 22 daN/mm.

The tyre P1 in accordance with the invention is provided with the same carcass layers (41, 42) as the controls. The main dimensions of the architecture of P1 are as follows:

TABLE 1

| | | | | | | Bead |
|---|---|---|---|---|---|---|
| | | | | | Sidewall | wire |
| LREC | LNDEG | LNDEG | EBT | HNC1 | height | diameter |
| (mm) | (mm) | (mm) | (mm) | (mm) | (mm) | (mm) |
| 18 | 4 | 4 | 5.3 | 30 | 129 | 6.10 |

It is possible to easily verify that the tyre P1 is in accordance with the invention.

The rolling resistance test was carried out according to the standard ISO 28580. For a tested tyre, the result is the rolling resistance coefficient, which represents the ratio of the resistance force to the forward travel of the vehicle by hysteresis of the tyres divided by the load carried.

The transverse cornering stiffness was measured on dedicated measuring machines, such as those sold by MTS.

The endurance test consists in subjecting a tyre to cycles of loading and pressure stresses when it is compressed against a rotating wheel. Such a test is described for example in Regulation No 30 of the UN/ECE (Economic Commission for Europe of the United Nations), which is required for the technical approval of tyres.

A result greater than (respectively less than) 100% indicates an improvement (respectively a diminution) in the performance criterion under consideration.

The results obtained are summarized in Table 2 below:

TABLE 2

| | | Transverse | |
|---|---|---|---|
| | Rolling | cornering | |
| | resistance | stiffness | Endurance |
| C1 | 100 | 100 | 100 |
| C2 | 100 | 98 | 100 |
| P1 | 100 | 99 | 102 |

The tyre of the invention satisfies the objective of having a level of technical performance identical to that of the control tyres C1 and C2. The level of transverse cornering stiffness is substantially diminished but in proportions which cannot be perceived by a user, and which do not adversely affect the behaviour of the vehicle.

The tyre P1 of the invention advantageously replaces tyres that have type A and/or type B beads. This solution improves the industrial performance compared with the successive manufacture of type A and type B tyres, which would require adapting the processes.

1-11. (canceled)

12. A tire for a passenger vehicle comprising:
two beads intended to be mounted on a rim, two sidewall layers connected to the beads, and a crown having a tread intended to come into contact with a ground, the crown having a first side connected to a radially outer end of one of the two sidewall layers and a second side connected to a radially outer end of the other one of the two sidewall layers;
a carcass reinforcement comprising a first carcass layer and a second carcass layer, each extending from the two beads through the sidewall layers as far as the crown, and each comprising a plurality of carcass reinforcing elements,
wherein the first carcass layer is anchored in the two beads by a turn-up around a reinforcing bead wire, so as to form, in each bead, a main part and a turn-up;
a bead filler layer, of elastomer compound, occupying a volume delimited by the main part, the turn-up, and at least partially a radially outer contour of the bead wire,
wherein radial distances LNDEG and LNDED are defined in a first and in a second bead as being radially inner distances of a first and of a second end of the second carcass layer from an axial straight line B1 tangential to the bead wire at a radially outermost point,
wherein the second carcass layer is laid axially and radially on an outside of the first carcass layer, and positioned in the bead axially on an inside of the turn-up of the first carcass layer, and axially on an outside of the bead filler layer such that the second carcass layer is in contact with the turn-up of the first carcass layer over a length LREC,
wherein, in each bead, the first carcass layer has a turn-up of length HNC1 ranging between 10% and 30% of a height of one of the sidewalls of the tire, the length HNC1 being measured from a first, radially innermost point of the bead wire to a second point constituting a radially outermost end of the turn-up of the first carcass layer,
wherein the length LREC is comprised in a range [0.6*HNC1; 0.9*HNC1],
wherein a maximum value of the distances LNDEG and LNDED is comprised in a range [2; 18] mm, and
wherein, in each bead, an axial thickness EBT of the bead filler layer measured from a radially innermost end of the second carcass layer to the main part of the first carcass layer is comprised in the range [EBTmin; EBTmax], where EBTmin is equal to 0.3 times an outside diameter of the bead wire, and EBTmax being equal to 1.2 times the outside diameter of the bead wire.

13. The tire according to claim 12, wherein the radial distances LNDEG and LNDED are identical in each of the two beads.

14. The tire according to claim 12, wherein the second carcass layer is discontinuous.

15. The tire according to claim 12, wherein a distributed breaking tension of each of the carcass layers is greater than or equal to 11 daN/mm, the distributed breaking tension being a product of a breaking force of a reinforcer of a layer times a pitch of the layer.

16. The tire according to claim 15, wherein the first and second carcass layers are made of same materials.

17. The tire according to claim 15, wherein the reinforcers of the carcass layers are textile cords, each cord being obtained by twisting a twist T2 of N strands of a textile material in a given direction D1, respectively in an S or Z direction, with N≥1, each strand resulting from overtwisting a twist T1 of a spun yarn of the textile material in an opposite direction D2, which is Z or S, respectively.

18. The tire according to claim 17, wherein the spun yarns are made of a hybrid assembly of filaments of textile materials.

19. The tire according to claim 17, wherein the number N of strands for the twisting ranges between 2 and 6.

20. The tire according to claim 17, wherein the overtwisting twist T1 and the twisting twist T2 are identical, and less than 500 turns per meter.

21. The tire according to claim 12, wherein, in each bead, a lateral reinforcing layer is positioned axially on an outside of the turn-up of the first carcass layer, and in contact on one side with the turn-up and on the other side at least partially, axially on the outside, with a sidewall layer.

22. The tire according to claim 21, wherein the bead filler layer and the lateral reinforcing layer of the bead are made of a same elastomer compound provided with an elastic shear modulus greater than or equal to 25 MPa, the elastic shear modulus being measured under alternating strain at a frequency of 10 Hz and at a temperature of 23° C.
